(19) United States
(12) Patent Application Publication
(10) Pub. No.: US 2003/0051588 A1
(43) Pub. Date: Mar. 20, 2003

(54) Tube-forming device

(76) Inventor: Charles J. Rice, Sanford, NC (US)

Correspondence Address: COATS & BENNETT, PLLC, P O BOX 5, RALEIGH, NC, 27602, US

(21) Appl. No.: 09/954,754

(22) Filed: Sep. 18, 2001

(51) Int. Cl. B26D 3/16

(52) U.S. Cl. 83/54; 83/189; 83/917

(57) ABSTRACT

A tube-forming device for notching and/or punching a tubular work piece includes a work piece holder to hold the tubular work piece, a tool insertable into an end of the work piece; a tool holder to hold the tool, and a dual action cam assembly to alternately drive the tool in first and second directions to engage the tool with first and second sides of the work piece.

### FIELD OF THE INVENTION

The present invention relates to tools for forming, notching and cutting tubular work piece and, more particularly, to a tube-forming device to perform operations on opposing sides of a tubular work piece without removing the tubular work piece from the tool.

### BACKGROUND OF THE INVENTION

Metal tubing is used as a structural component in many consumer products, such as bicycles, furniture, lawn and garden equipment, fencing, and playground equipment. Joining two pieces of tubular stock requires notching the end of a first piece of stock to fit against the curved surface of a second piece of stock. The two pieces can then be joined by welding or brazing.

Machines for forming notches in tubular stock are known. For example, it is known to use a punch and die to shear a notch in the end of a tubular work piece. A common practice is to enclose the tubular work piece in a die that extends around the outer periphery of the work piece and guide a punch through the work piece with sufficient force to shear away the material necessary to produce the desired shape. Because the wall initially contacted by the punch is not supported internally, the wall of the tube is deformed by this process and requires secondary finishing operations.

Another common practice involves the use of a die that extends around the outer periphery of the work piece as described above. The punch is inserted in the open end of the work piece. The punch shears away material on one side of the work piece. The work piece is then removed from the machine, rotated 180 degrees, and reinserted to shear the other side of the work piece. This method has several drawbacks. First, it requires two operations to form a notch in both sides of the work piece. Secondly, care must be taken when reinserting the work piece to insure that the notches in the two sides are properly aligned.

Accordingly, there is a need for a tube notching device that is can form notches in tubular stock in a single operation without requiring secondary operations to prepare the work piece for joining.

### SUMMARY OF THE INVENTION

The present invention is a tube-forming device for notching and/or punching a tubular work piece. The tube-forming device comprises a work piece holder to hold the tubular work piece, a tool insertable into an end of the work piece; a tool holder to hold the tool, and a dual action cam assembly to alternately drive the tool in first and second directions to engage the tool with first and second sides of the work piece.

The work piece holder may comprise a fixed die block having an opening therein to accommodate one or more interchangeable dies. The dies are in the form of a sleeve that surrounds the work piece outer circumference of the work piece. A cutting edge is formed at one end of the sleeve that cooperates with the tool to shear material from the work piece.

The tool may, for example, comprise a shear or punch that is shaped to form a notch or other shape in the end of the work piece. The tool may also comprise piercing tool to form openings in the work piece.

The tool holder may comprise a carrier block that slides in a channel in the die block. The carrier block may include an opening therein to removably receive one or more interchangeable tools. The carrier block may further include an opening for the dual action cam assembly that produces a reciprocating motion.

### BRIEF DESCRIPTION OF THE DRAWINGS

FIG. 1 is a perspective view of the tube forming device of the present invention.

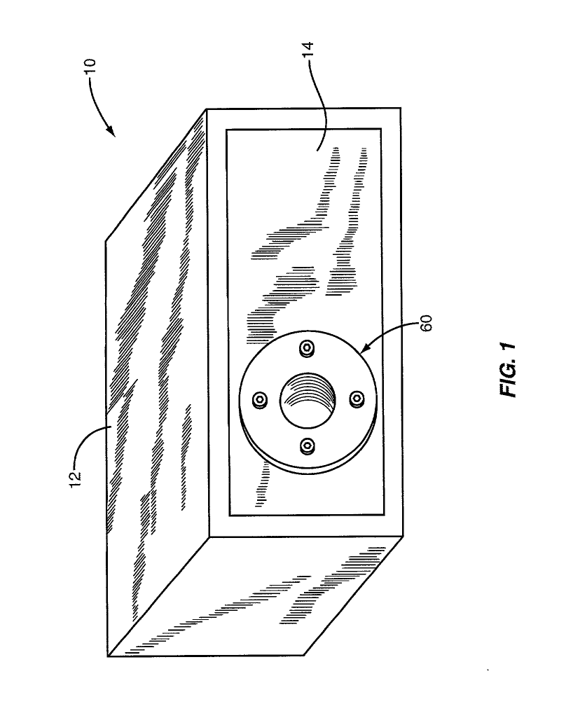

FIG. 2 is an exploded perspective view of a die block used in the tube forming device.

FIG. 3 is an exploded perspective view of a carrier block used in the tube notching apparatus to carry a tool.

FIG. 4 is a perspective view of a die that inserts into the die block.

FIG. 5 is a perspective view of a tool that cooperates with the die to shear the work piece.

FIG. 6 is a longitudinal cross-section of the tool assembly.

FIG. 7 is a transverse cross-section of the tool assembly.

FIG. 8 is an exploded cross-section of the tool assembly.

FIGS. 9A through 9D are schematic illustrations showing the operation of the dual action cam assembly.

### DETAILED DESCRIPTION OF THE INVENTION

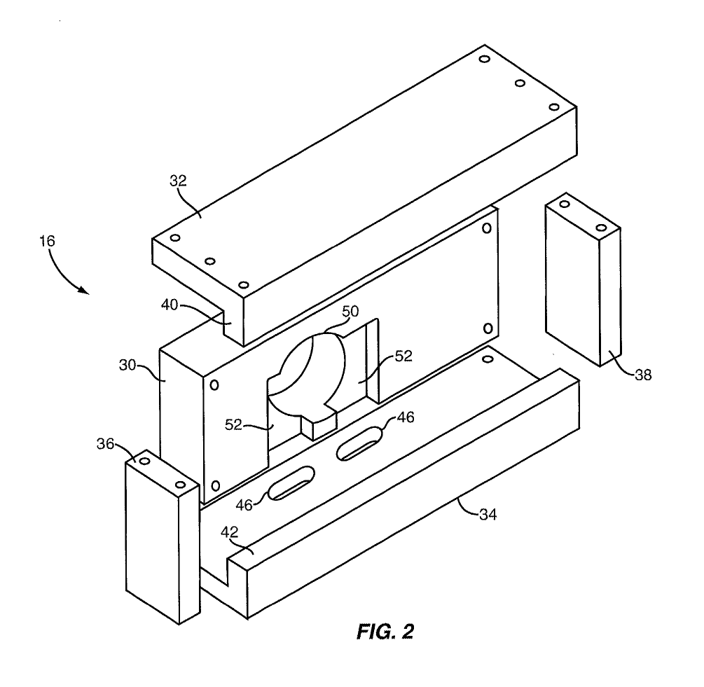

Referring now to the drawings, the tube-forming device of the present invention is shown therein and indicated generally by the numeral 10. The tube-forming device 10 comprises a housing 12 and a tool assembly 14. The tool assembly 14, which is shown in more detail in FIGS. 2-9, includes a die block assembly 16 and a carrier block assembly 18. The die block assembly 16 accepts interchangeable dies 60 that receive tubular work pieces of varying sizes. The carrier block assembly 18 accepts a tool 90, such as a shear or punch, that is used to notch or perforate the tubular work piece. A dual action cam assembly 100 causes the carrier block assembly 18 to linearly reciprocate. As will be described hereinafter in greater detail, a tubular work piece slides into the die 60 and is notched or perforated on two opposing sides by the tool 90 as it reciprocates back and forth.

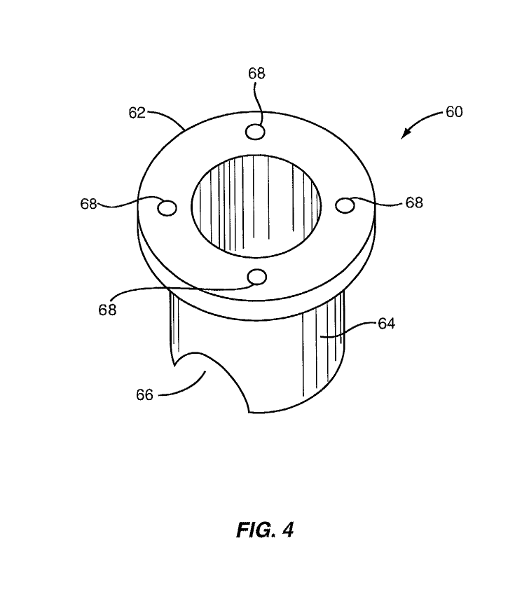

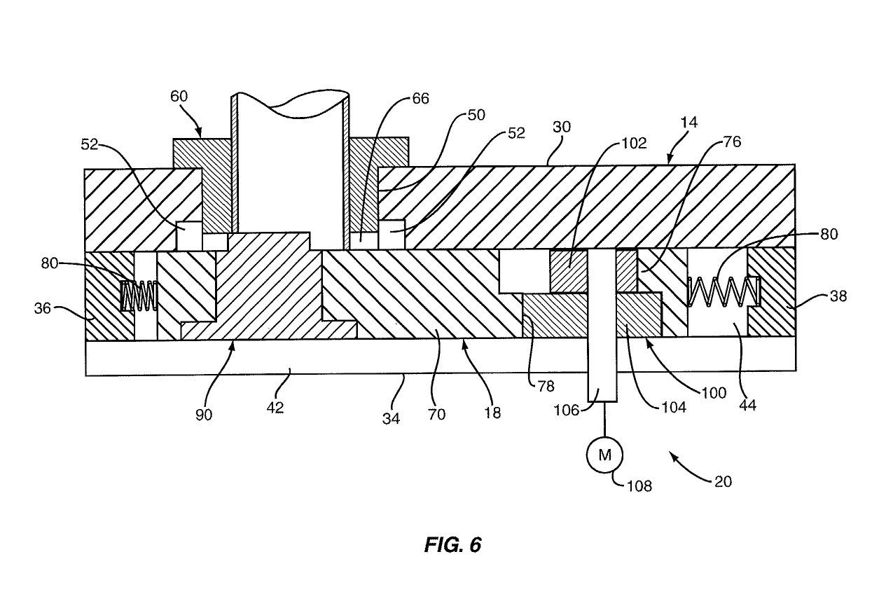

FIG. 2 is an exploded perspective view of the die block assembly 16, which functions as a work piece holder. The die block assembly 16 includes a die block 30 and one or more interchangeable dies 60. The die block 30 includes a top plate 32, bottom plate 34, and end plates 36 and 38. Die block 30 includes an opening 50 to receive one or the interchangeable dies 60, shown in FIG. 4. Clearance areas 52 are formed on the inner surface of the die block 30 on either side of the opening 50. Clearance areas 52 provide clearance for the material that is removed from the tubular work piece. The removed material falls through openings 46 in the bottom plate 34. The top plate 32 includes a down-turned lip 40. The bottom plate 34 includes an up-turned lip 42. The die block 30, top plate 32, and bottom plate 34 form a channel 44 when assembled together (see FIG. 6). The ends of the channel 44 are closed off by end blocks 36 and 38.

FIG. 4 is a perspective view of an exemplary die 60 that fits into the opening 50 of the die block 30. The die 60 comprises a generally cylindrical sleeve 64 having a flange 62 at one end thereof. In the embodiment shown in FIG. 4, the end of the sleeve 64 opposite the flange 62 includes a notch 66. The flange 62 includes a series of holes 68 that accept bolts for attaching the die 60 to the die block 30. The inner diameter of the die 60 is sized to receive a tubular work piece of a predefined outside diameter. Typically, the tube-forming device 10 would include a plurality of dies 60 adapted to receive tubular work pieces of different sizes and adapted to form notches of a plurality of different shapes and sizes.

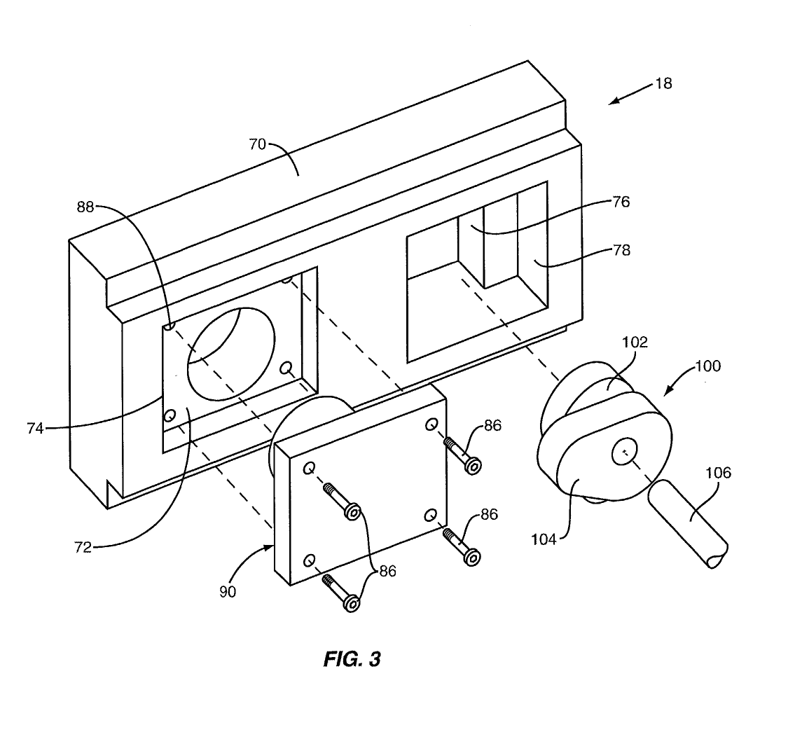

The carrier block assembly 18 is slideably mounted in the channel 44 in the die block assembly 16 so as to be movable relative to the die block assembly 16. The carrier block assembly 18 comprises a carrier block 70 and tool 90. Carrier block 70 includes a cylindrical opening 72 and generally rectangular recess 74, which are adapted to receive the tool 90, as will be hereinafter described. Carrier block 70 further includes a pair of cam openings 76 and 78. Cam openings 76 and 78 are rectangular in form and are formed in opposing sides of the carrier block 70. Cam opening 76 is formed in the front side of the carrier block 70, while cam opening 78 is formed in the back side of the carrier block 70. Cam openings 76 and 78 are offset with respect to one another as shown in FIG. 3.

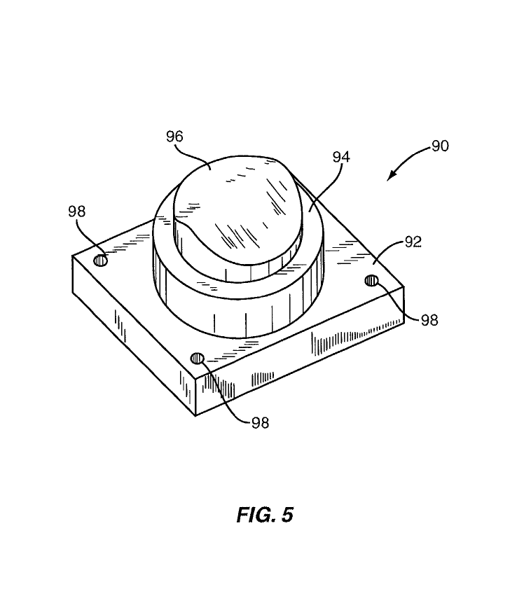

The tool 90, shown in FIG. 5, comprises a base 92, intermediate portion 94, and a head portion 96. The intermediate portion 94 of the tool 90 is received in the cylindrical opening 72 in the carrier block 70, while the base 92 is received in the recess 74. The head portion 96 of the tool 90 projects from the front of the carrier block 70. In the disclosed embodiment, the head portion 96 of the tool 90 functions as a shearing member to shear material from the tubular work piece. More particularly, the head portion 96 is shaped to notch the tubular work piece. The head portion 98 could have a variety of shapes to form notches of different shapes (e.g., v-shaped). Also, the head portion 96 could comprise a punch designed to form perforations of various shapes in the work piece.

Tool 90 is designed to be easily removed from the carrier block 70. A series of openings 98 are formed in the base 92 of the tool 90. Openings 98 align with corresponding openings 88 in the carrier block 70. Bolts 86 secure the tool 90 to the carrier block 70.

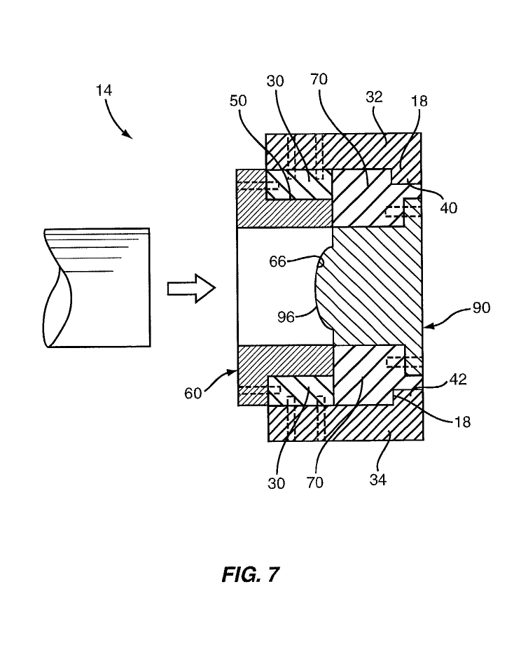

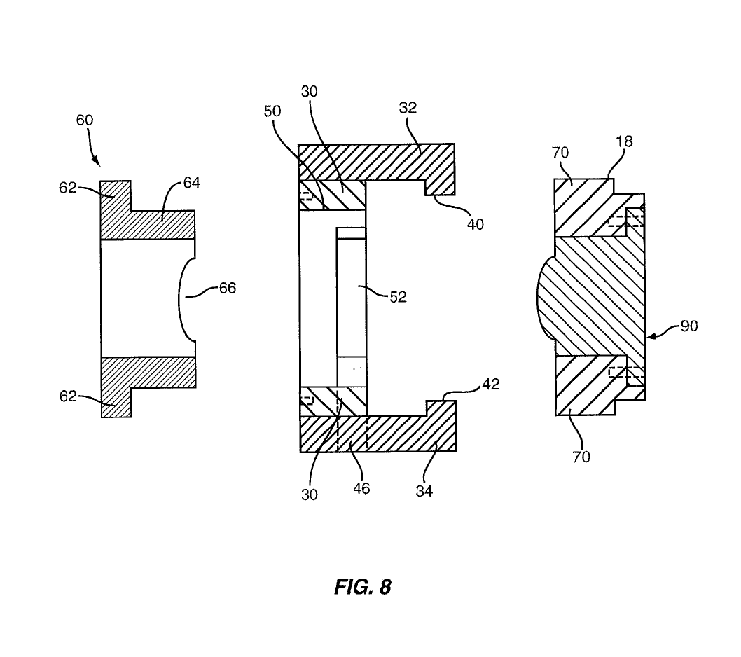

FIG. 7 illustrates the tool assembly 14 in cross-section assembled with the die 60 and tool 90 inserted. Note that the shape of the notch 66 in the die 60 matches the configuration of the head portion 96 of the tool 90 so that the two parts function as a shear. An exploded cross-section of the tool assembly 14 is shown in FIG. 8.

In a normal or neutral position, the carrier block 70 is positioned such that the tool 90 is centered with respect to the die 60. Springs 80 may be used to bias the carrier block 70 to the neutral position. While the carrier block 70 is in the neutral position, a work piece may be inserted into the die 60 over the head portion 96 of the tool 90 until the work piece engages the land surrounding the head portion 96. As the carrier block 70 moves in either direction from the neutral position, the tool 90 shears off material from the work piece as shown in FIG. 6.

A dual action cam assembly 100 reciprocates the carrier block 70 relative to the die block assembly 16. The dual action cam assembly 100 comprises a first cam 102, a second cam 104, a cam shaft 106, and a motor 108. Cam 102 is disposed in cam opening 76 and cam 104 is disposed in cam opening 78. The main lobes of the cams 102 and 104 are disposed at an angle of approximately 90° with respect to one another. Cams 102 and 104 are mounted on a cam shaft 106 and rotate as a single unit. The cams 102 and 104 push against the walls of the opening 76 and 78, respectively, causing the carrier block 70 to reciprocate linearly in channel 44 when the cams 102 and 104 are rotated. While the dual action cam assembly in the disclosed embodiment comprises two separate cams 102 and 104, a single cam with multiple lobes could be designed for equivalent operation.

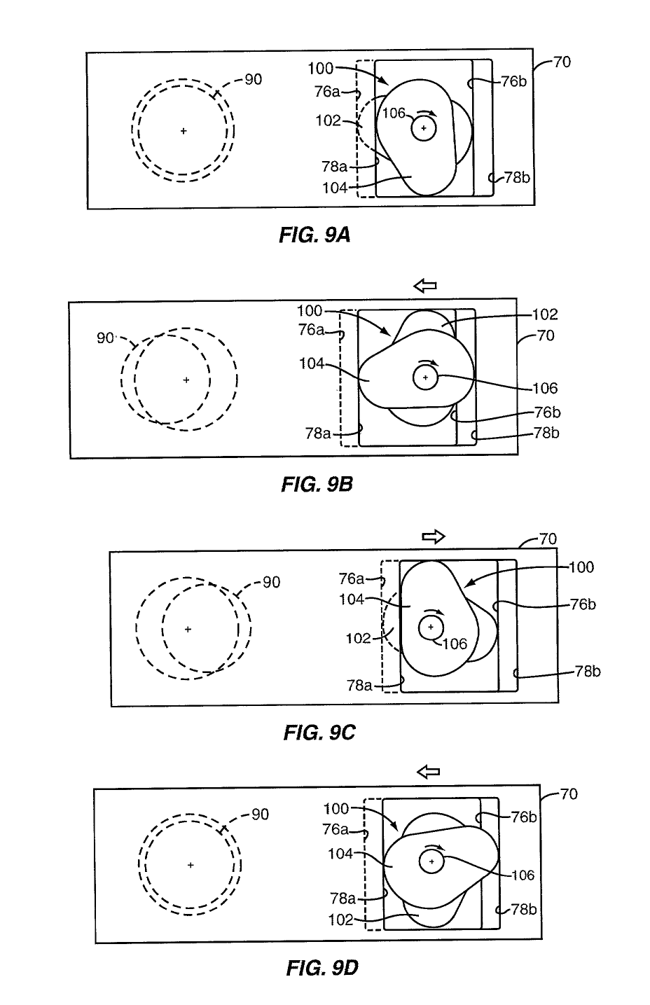

FIGS. 9A-9D illustrate the operation of the cams 102 and 104. In FIG. 9A, the carrier block 70 is in a neutral position. In this position, the tool 90 is aligned with the axis of the die 60. The cams 102 and 104 rotate clockwise to the position shown in FIG. 9B to begin a first phase of the tool cycle. As the cams 102 and 104 rotate from the position shown in FIG. 9A to the position shown in FIG. 9B, cam 102 pushes against the front wall 76A of cam opening 76. The action of the cam 102 pressing against front wall 76A pushes the carrier block 70 to the left (as seen in FIG. 9B). As the carrier block 70 moves to the left, the tool 90 shears material on one side of the work piece. As the dual action cam assembly 100 continues rotating, cam 102 begins pushing on the rear wall 76B of cam opening 76, causing the carrier block 70 to begin moving in a rearward direction. This is the start of a second phase of the tool cycle. When the cam assembly 100 reaches the position shown in FIG. 9C, the carrier block 70 will be in the rear-most position. As the carrier block 70 moves from the position shown in FIG. 9B to the position shown in FIG. 9C, the tool 90 shears off material on the rear side of the work piece. As the cam assembly 100 rotates from the position shown in FIG. 9C to the position shown in FIG. 9D, cam 104 pushes against the front wall 78A of the cam opening 78 to push the carrier block 70 back to the neutral position. This is the third phase, referred to as the idle phase, of the tool cycle. During the idle phase a new work piece may be inserted.

The tube-forming device 10 of the present invention is a simple, yet highly, efficient machine for notching or perforating a tubular work piece. Unlike prior art to notching devices, the tube-forming device 10 of the present invention does not require the operator to remove and reinsert the work piece in order to notch both sides of the work piece. Using the tubeforming device 10 of the present invention, the work piece is simply inserted into the die 60 and both sides are notched or punched without any further action taken on the part of the operator. The operator simply inserts and removes the work pieces in synchronism with the action of the carrier block 70. Using the present invention, a single operator could process up to 3600 work pieces per hour.

The present invention may, of course, be carried out in other specific ways than those herein set forth without departing from the spirit and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A tube-forming device comprising:
a) a work piece holder to receive a tubular work piece;
b) a tool insertable into an end of the tubular work piece held by the work piece holder;
c) a tool holder to receive the tool and movable in first and second directions;
d) a first cam to drive the tool holder in a first direction during a first phase of a tool cycle to engage the tool with a first side of the work piece; and
e) a second cam driven synchronously with the first cam to drive the tool holder in a second direction during a second phase of the tool cycle to engage the tool with a second side of the work piece.

2. The tube-forming device of claim 1 wherein the work piece holder comprises a die block having an opening therein to receive the work piece.

3. The tube-forming device of claim 2 wherein the work piece holder further comprises an interchangeable die insertable into the opening in the die block.

4. The tube-forming device of claim 3 wherein the die comprises a sleeve that surrounds the work piece.

5. The tube-forming device of claim 4 wherein the die further comprises a cutting edge that cooperates with the tool to shear the work piece.

6. The tube-forming device of claim 1 wherein the tool comprises a shear.

7. The tube-forming device of claim 6 wherein the shear is shaped to notch the end of the work piece.

8. The tube-forming device of claim 1 wherein the tool comprises a piercing tool to form an opening in the work piece.

9. The tube-forming device of claim 1 further comprising a plurality of interchangeable tools.

10. The tube-forming device of claim 1 wherein the tool holder comprises a reciprocating carrier block having an opening therein to receive the tool.

11. The tube-forming device of claim 10 wherein the carrier block has first and second cam openings therein adapted to receive the first and second cams respectively.

12. The tube-forming device of claim 11 wherein the first cam opening has a first cam surface engaged by the first cam during a first phase of the tool cycle to move the carrier block in a first direction and wherein the second cam opening has a second cam surface engaged by the second cam during a second phase of the tool cycle to move the carrier block in a second direction.

13. The tube-forming device of claim 1 further comprising biasing means to bias the carrier block to a neutral position in which the tool is centered with respect to the work piece.

14. The tube-forming device of claim 13 wherein the biasing means comprises at least one spring that presses against the carrier block.

15. A tube-forming device comprising:
a) a work piece holder to receive a tubular work piece;
b) a tool insertable into an end of the tubular work piece held by the work piece holder;
c) a tool holder to receive the tool and movable in first and second directions; and
d) a dual action cam assembly to drive the tool holder in first direction during a first phase of a tool cycle to engage the tool with a first side of the work piece, and to drive the tool holder in a second direction during a second phase of the tool cycle to engage the tool with a second side of the work piece.

16. The tube-forming device of claim 15 wherein the work piece holder comprises a die block having an opening therein to receive the work piece.

17. The tube-forming device of claim 16 wherein the work piece holder further comprises an interchangeable die insertable into the opening in the die block.

18. The tube-forming device of claim 17 wherein the die comprises a sleeve that surrounds the work piece.

19. The tube-forming device of claim 18 wherein the die further comprises a cutting edge that cooperates with the tool to shear the work piece.

20. The tube-forming device of claim 15 wherein the tool comprises a shear.

21. The tube-forming device of claim 20 wherein the shear is shaped to notch the end of the work piece.

22. The tube-forming device of claim 15 wherein the tool comprises a piercing tool to form an opening in the work piece.

23. The tube-forming device of claim 15 further comprising a plurality of interchangeable tools.

24. The tube-forming device of claim 15 wherein the tool holder comprises a reciprocating carrier block having an opening therein to receive the tool.

25. The tube-forming device of claim 24 wherein the carrier block has first and second cam openings therein adapted to receive the first and second cams respectively.

26. The tube-forming device of claim 25 wherein the first cam opening has a first cam surface engaged by the first cam during a first phase of the tool cycle to move the carrier block in a first direction and wherein the second cam opening has a second cam surface engaged by the second cam during a second phase of the tool cycle to move the carrier block in a second direction.

27. The tube-forming device of claim 15 further comprising biasing means to bias the carrier block to a neutral position in which the tool is centered with respect to the work piece.

28. The tube-forming device of claim 27 wherein the biasing means comprises at least one spring that presses against the carrier block.

29. The tube-forming device of claim 15 wherein the dual action cam assembly comprises a first cam to drive the tool holder in first direction during a first phase of a tool cycle to engage the tool with a first side of the work piece and a second cam to drive the tool holder in second direction during a second phase of a tool cycle to engage the tool with a second side of the work piece.

30. A method of forming the end of a tubular work piece comprising:
a) inserting a work piece into a work piece holder such that the work piece inserts over a tool;
b) rotating a dual action cam assembly to reciprocate the tool during a tool cycle;
c) wherein during a first phase of the tool cycle, the tool is driven in a first direction by the cam assembly to engage a first side of the tubular work piece; and
d) wherein during a second phase of the tool cycle, the tool is driven in a second direction by the cam assembly to engage a second side of the tubular work piece.

31. The method of claim 30 wherein the tool is idle during a third phase of the tool cycle to allow a work piece to be inserted into the work piece holder.
